(19) United States
(12) Patent Application Publication
(10) Pub. No.: US 2006/0052058 A1
(43) Pub. Date: Mar. 9, 2006

(54) Method of transferring data between two PHS handsets in a short distance

(75) Inventors: Cheng-Shing Lai, Taipei (TW); Jun-Sheng Zhang, Nanking (CN); Xiao-Long Fan, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/139,640

(22) Filed: May 31, 2005

(30) Foreign Application Priority Data
Sep. 6, 2004 (TW) 093126842

(51) Int. Cl. H04Q 7/20

(52) U.S. Cl. 455/41.2; 455/41.3

(57) ABSTRACT

The present invention is to provide a method of transferring data between two PHS handsets in a short distance, which comprises the steps of registering two PHS handsets in a group, assigning a channel for data communication therebetween, configuring two PHS handsets as a sender and a recipient in the group, establishing a connection between the PHS handsets, causing the sender to send packets as divided data to the recipient, performing a data transfer mechanism to send the packets to the recipient, assembling the actually received packets, inspecting and storing the data in a reference data storage by the recipient, for sharing data therebetween.

### FIELD OF THE INVENTION

The present invention relates to PHS (Personal Handyphone System), more particularly to a method by utilizing the advantages of communication features of PHS handset for transferring data between two PHS handsets in a short distance and increasing the competitiveness in the PHS mobile phone market alike for sharing data between users.

### BACKGROUND OF THE INVENTION

In recent years, mobile communication known as a rapid, spectacular development of technology has been deregulated monopoly to open to private mobile communication industry. Moreover, cellular phone users are increased in an even fast pace due to wide availability of mobile communication services. A cellular phone is advantageous for its portability. This is the reason for the booming of cellular phone industry. A low power PHS (Personal Handyphone System) handset is gaining popularity recently. PHS handset is a compact, inexpensive communication tool. PHS handset is much more powerful than a typical wire telephone. It is found that many families have one or more PHS handsets in addition to a wire telephone installed in the home.

PHS has made a significant progress in recent years. Also, PHS handsets are widely promoted by many telephone companies. As a result, more and more people choose to use PHS handsets. In many powerful, attractive PHS handsets, a data transmission particularly voice data, communication used among PHS handsets is increased gradually.

However, voice data sharing among PHS handsets is restricted. As such, it is inconvenient for a PHS handset user to share voice data with another one, resulting in a hindering of voice data transferring or receiving between two PHS handsets. Currently, a couple of techniques are employed for sharing voice data. The first one employs a third party as means for sharing voice data. For example, a first PHS handset transfers voice data to a second PHS handset via a PC (personal computer) so as to achieve the purpose of sharing voice data. The second one is that a first PHS handset transfers voice data to a second PHS handset over the Internet (i.e., uploading and downloading) so as to achieve the purpose of sharing voice data.

In view of the fact that more and more people use PHS handsets as their portable communication tools, the present inventor thus spends a lot of time to improve PHS handset with a goal of providing additional advanced features in order to increase its competitiveness among similar products in the market. Thus, it is desirable to provide a novel technique of transferring data from a first PHS handset to a second PHS handset as an alternative to the existing techniques of data communication via PCs for user choice.

### SUMMARY OF THE INVENTION

After considerable research and experimentation, a method of transferring data between two PHS handsets in a short distance according to the present invention has been devised so as to overcome the above drawbacks of the prior art (e.g., voice data share among PHS handsets restricted, being inconvenient for a PHS handset user to share voice data with another one, hindering of voice data transferring or receiving between two PHS handsets, and user inconvenience).

It is an object of the present invention to provide a method of transferring data between two PHS handsets in a short distance. By utilizing this method and fully taking advantage of communication feature of PHS handset, it is possible of transferring data (e.g., voice data) between two PHS handsets in a short distance without the involvement of a CS (cell station). Moreover, cost of modifying software and hardware for the data transfer is not required to add. As a result, an effective option is provided to PHS handset users for transferring data among them.

It is another object of the present invention to provide additional advanced features to PHS handset in order to increase its competitiveness among similar products in the market and fully take advantage of communication feature of PHS handset, and perform a method of transferring data between two PHS handsets in a short distance.

The above and other objects, features and advantages of the present invention will become apparent from the following detailed description taken with the accompanying drawings.

### BRIEF DESCRIPTION OF THE DRAWINGS

FIG. 1 is a flow chart illustrating a process of transferring data from a first PHS handset (i.e., sender) to a second PHS handset (i.e., recipient) by establishing a connection therebetween according to the invention;

FIG. 2 is a flow chart illustrating a process of establishing a connection between the recipient and the sender by the recipient according to the invention;

FIG. 3 is a flow chart illustrating a process of continuously sending data in the form of packet from the sender to the recipient according to the invention;

FIG. 4 is a flow chart illustrating a process of assembling received packets to form data in its original form at the recipient and transferring an ACK (acknowledgement) to the sender according to the invention; and

FIG. 5 is a flow chart illustrating a process of sending data in the form of packet from the sender to the recipient according to the invention.

### DETAILED DESCRIPTION OF THE PREFERRED EMBODIMENTS

The invention is directed to a method of transferring data between two PHS handsets in a short distance. The method comprises the steps of registering two PHS handsets in a group, assigning a channel as means for data communication therebetween, configuring a first PHS handset as a sender and a second PHS handset as a recipient in the group, establishing a connection between the PHS handsets by performing a calling mode of PHS handset, causing the sender to send data (e.g., voice data) to the recipient wherein the sender divides data into a plurality of packets of predetermined size complying with PHS handset communication requirements, sequentially sending the packets from the sender to the recipient over the wireless channel by performing a data transfer mechanism, assembling the actually received packets by the recipient into the original data, inspecting the data by the recipient, and storing the data in a reference data storage by the recipient. By utilizing this method, it is possible of sharing data between two PHS handsets and wirelessly transferring data between two PHS handsets in a short distance (e.g., 100 meters).

In the invention direct communication between two PHS handsets in the same group is characterized in that two PHS handsets are able to directly communicate over a channel without the involvement of a CS (cell station). Functional channels for communicating data between two PHS handsets comprise a SCCH (signaling control channel), a TCH (traffic channel), and a FACCH (fast associated control channel). In the invention, data is sent over the FACCH.

In the invention, a first PHS handset is configured as a sender, a second PHS handset is configured as a recipient in the group, and data communication between the sender and the recipient is free. The technique of registering PHS handsets in a group is well known and it is not pertinent to be covered in the present invention. Accordingly, further description thereof is omitted.

In the invention in the data transfer mechanism, the sender will wait for an ACK (acknowledgement) from the recipient after each time the sender sends a packet and until the data of the packet is inspected by the recipient. The sender will either send a next packet immediately after receiving an ACK indicating a correct transmission or wait to perform other operations. The sender will send the previously sent packet again after receiving an ACK indicating an incorrect transmission. The attempted transmission will end after the third time of the ACKs indicating an incorrect transmission happened, and then a failure message and a reminder informing the user to check machine and verify process steps are prompted on a display of the sender prior to continuing sending a packet again. Alternatively, after sending a packet, the sender waits and will send the previously sent packet again after a time-out control has elapsed with no ACK being received from the recipient. The attempted transmission will end after third time of packet retransmission without receiving an ACK from the recipient, and then a failure message and a reminder informing the user to check machine and verify process steps are prompted on the display of the sender prior to sending a packet again.

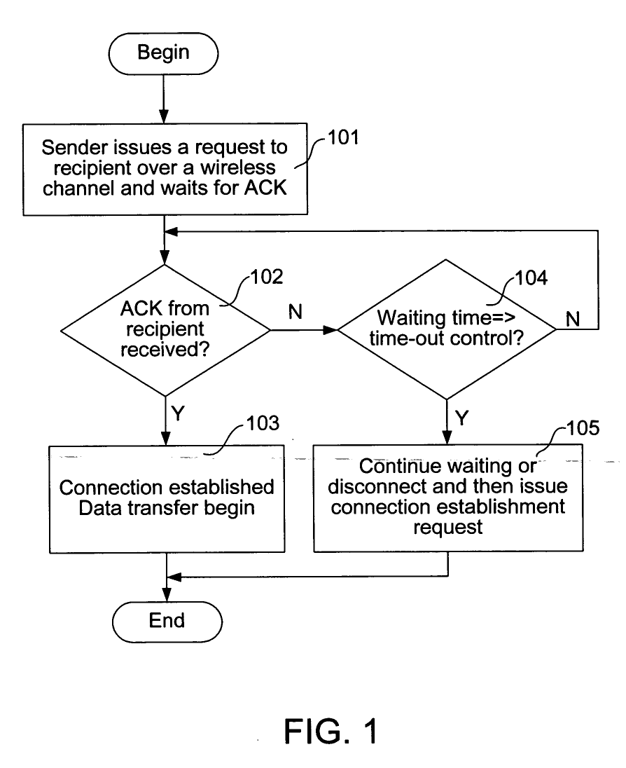

Referring to FIG. 1, there is shown a process of transferring data from a first PHS handset (i.e., sender) to a second PHS handset (i.e., recipient) by establishing a connection therebetween according to the invention. Thus, it is possible of transferring data between two PHS handsets in a short distance.

In step 101, the sender issues a request of connection to the recipient over a wireless channel and then waits for an ACK from the recipient.

In step 102, it is determined whether an ACK from the recipient has been received (i.e., connection establishment permitted) or not. If yes, the process goes to step 103. Otherwise, the process skips to step 104.

In step 103, connection between the sender and the recipient is established. At the same time, the sender begins to transfer data (e.g., voice data) to the recipient. After that, the process ends accordingly.

In step 104, it is determined whether waiting time (i.e., time spent in waiting reply from the recipient) has exceeded over a time-out control or not. If yes, the process goes to step 105. Otherwise, the process loops back to step 102.

In step 105, the sender either continues waiting or disconnects the connection and then issues another request for establishing connection again.

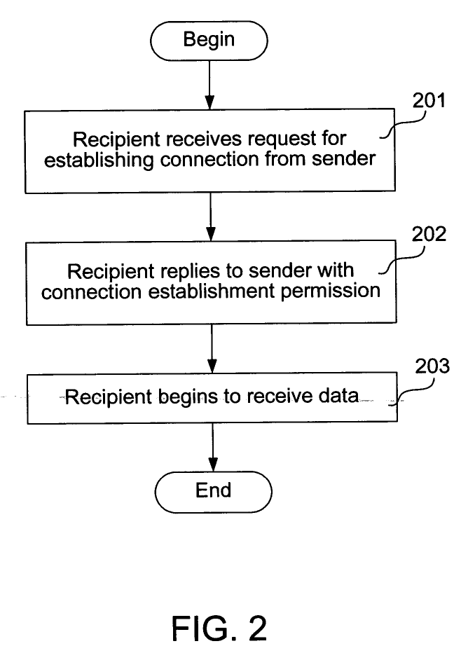

Referring to FIG. 2, it illustrates a process of establishing a connection between the sender and the recipient by the recipient according to the invention.

In step 201, the recipient receives the request for establishing connection from the sender.

In step 202, the recipient replies to the sender with an ACK of connection establishment permission.

In step 203, the recipient begins to receive data. After that, the process ends accordingly.

Note that the reply in step 202 to the sender is either made automatically or made manually according to a command inputted into the recipient (i.e., manual reply mode). Therefore, a rejection can be made in the manual reply mode.

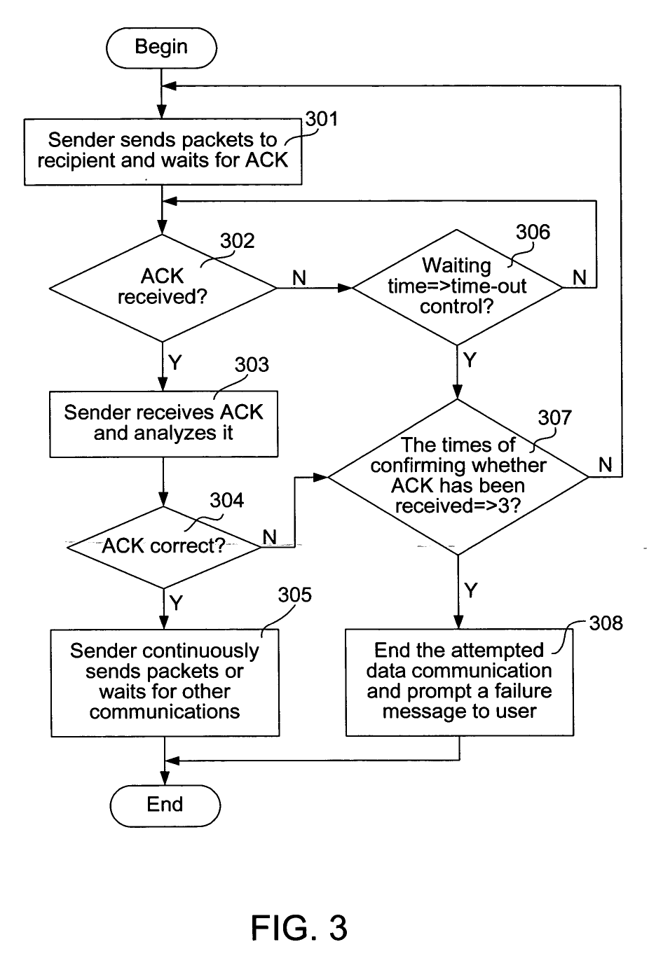

Referring to FIG. 3, it illustrates a process of continuously sending data in the form of packet from the sender to the recipient according to the invention.

In step 301, the sender sends data in the form of packet to the recipient and then waits for an ACK from the recipient.

In step 302, it is determined whether the ACK from the recipient has been received or not. If yes, the process goes to step 303. Otherwise, the process skips to step 306.

In step 303, the sender receives the ACK and analyzes the ACK.

In step 304, it is determined whether the ACK is correct or not. If yes, the process goes to step 305. Otherwise, the process skips to step 307.

In step 305, the sender continuously sends data in the form of packet to the recipient or waits for other communications. After that, the process ends accordingly.

In step 306, it is determined whether waiting time (i.e., time spent in waiting reply (e.g., ACK) from the recipient) has exceeded over a time-out control or not. If yes, the process goes to step 307. Otherwise, the process loops back to step 302.

In step 307, it is determined whether the times of confirming whether ACK has been received is equal to three or not. If yes, the process goes to step 308. Otherwise, the process loops back to step 301.

In step 308, the attempted data communication is ended and a failure message is prompted on the display of the sender. After that, the process ends accordingly.

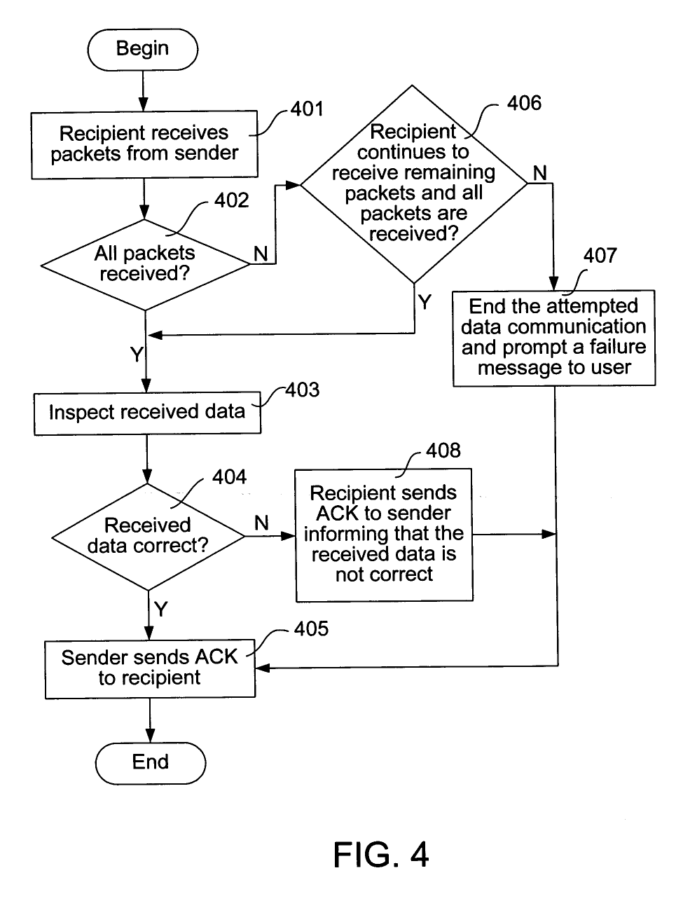

Referring to FIG. 4, it illustrates a process of assembling received packets to form data in its original form at the recipient and sending an ACK to the sender according to the invention.

In step 401, the recipient receives data packets from the sender.

In step 402, it is determined whether all data packets are received or not. If yes, the process goes to step 403. Otherwise, the process skips to step 406.

In step 403, the recipient inspects the actually received data.

In step 404, it is determined whether the received data is correct or not. If yes, the process goes to step 405. Otherwise, the process skips to step 408.

In step 405, the recipient sends an ACK to the sender. After that, the process of transferring data ends accordingly.

In step 406, the recipient continues to receive remaining packets and then it is determined whether all packets are received in a predetermined period of time or not. If yes, the process loops back to step 403. Otherwise, the process goes to step 407.

In step 407, the attempted data communication is ended and a failure message is prompted on a display of the recipient. After that, the process of transferring data ends accordingly.

In step 408, the recipient sends an ACK to the sender informing that the received data is not correct. After that, the process ends accordingly.

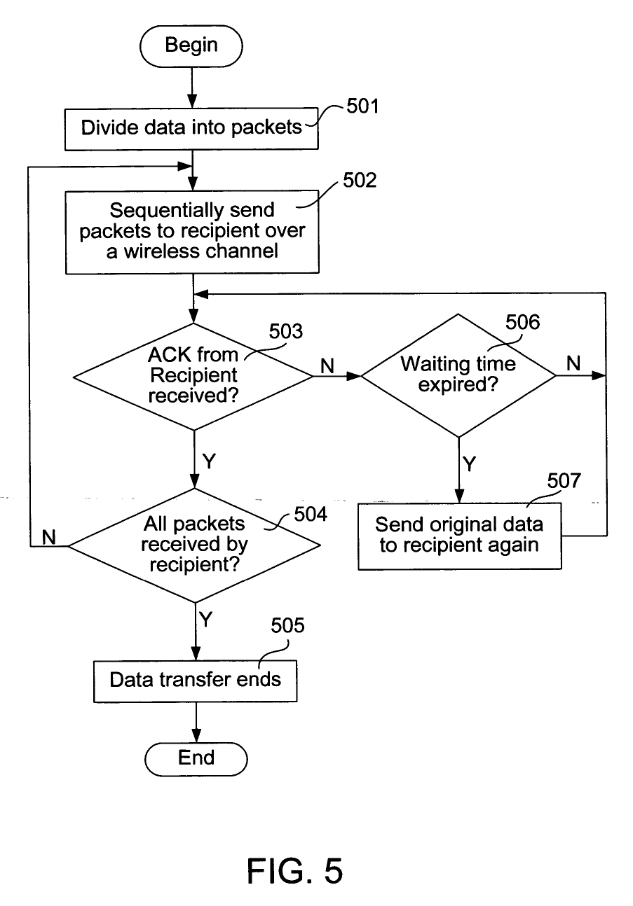

Referring to FIG. 5, it illustrates a process of sending data in the form of packet from a sender to a recipient according to the invention.

In step 501, the sender divides data into a plurality of packets of predetermined size.

In step 502, the sender sequentially sends data packets to the recipient over a wireless channel.

In step 503, During waiting time, it is determined whether an ACK from the recipient has been received or not. If yes, the process goes to step 504. Otherwise, the process skips to step 506.

In step 504, it is determined whether all data packets have been received by the recipient or not. If yes, the process goes to step 505. Otherwise, the process loops back to step 502.

In step 505, data transfer is completed. After that, the process ends accordingly.

In step 506, it is determined whether waiting time has expired or not. If yes, the process skips to step 507. Otherwise, the process loops back to step 503.

In step 507, the sender sends the original data packets to the recipient again prior to looping back to step 503.

The above processes illustrate data transferring from a sender to a recipient in which the recipient has to sequentially assemble the actually received packets into the original data.

While the invention herein disclosed has been described by means of specific embodiments, numerous modifications and variations could be made thereto by those skilled in the art without departing from the scope and spirit of the invention set forth in the claims.

What is claimed is:

1. A method of transferring data between two Personal Handyphone System (PHS) handsets in a short distance by registering two PHS handsets in a group and assigning a wireless channel as means for data communication therebetween, which comprises the following steps for performing data communication:
configuring a first PHS handset as a sender and a second PHS handset as a recipient in the group and establishing a connection between the first and second PHS handsets by performing a calling mode in the first and second PHS handsets respectively;
causing the sender to send data to the recipient after the sender divides data into a plurality of packets of predetermined size complying with communication requirements of the PHS handsets;
sending the packets from the sender to the recipient over the wireless channel by performing a data transfer mechanism;
assembling the received packets into the original data, inspecting the data and then storing the data in a reference data storage by the recipient, thereby sharing data between two PHS handsets and wirelessly transferring data therebetween in a short distance.

2. The method of claim 1, wherein in the data transfer mechanism, the sender will wait for an ACK from the recipient each time after the sender sends a packet and until the packet is inspected by the recipient, and the sender will either send a next packet immediately after receiving an ACK from the recipient indicating a correct transmission or wait to perform other operations.

3. The method of claim 2, wherein the sender will send the previously sent packet again after receiving an ACK indicating an incorrect transmission, and the attempted data transmission will end after predetermined time of ACKs indicating an incorrect transmission happened, and then a message informing to check machine and verify process steps is prompted on a display of the sender prior to sending data again.

4. The method of claim 2, wherein the sender waits after sending a packet, and will send the previously sent packet again after a time-out control has elapsed with no ACK being received from the recipient.

5. The method of claim 4, wherein the attempted data transmission will end after predetermined time of packet retransmission happened without receiving ACK thereafter, and a message informing to check machine and verify process steps is prompted on a display of the sender prior to sending data again.
